(19) United States
(12) Patent Application Publication
(10) Pub. No.: US 2010/0295674 A1
(43) Pub. Date: Nov. 25, 2010

(54) Integrated health management console

(75) Inventors: Jeffrey Hsieh, Dove Canyon, CA (US); Dennis Kwan, San Diego, CA (US); Suresh Singamsetty, Aliso Viejo, CA (US)

Correspondence Address: SAILE ACKERMAN LLC, 28 DAVIS AVENUE, POUGHKEEPSIE, NY, 12603, US

(73) Assignee: SilverPlus, Inc.

(21) Appl. No.: 12/454,714

(22) Filed: May 21, 2009

(51) Int. Cl. G08B 1/08; G05B 19/00

(52) U.S. Cl. 340/539.12; 340/5.1

(57) ABSTRACT

A health management system is described, comprising at least one console, one or more devices in two-way wireless communication with the console wherein the console acts as an intelligent gateway through which the one or more devices may communicate to external data and voice networks, and an alert system wherein an alert is triggered by one or more of a user's action and pre-set alarm criteria and wherein the triggering of an alert causes the console to take an action.

### BACKGROUND OF THE INVENTION

(1) Field of the Invention

The invention relates to a health management system for the home, and more particularly, a health management system for the home that combines a personal emergency response system with vital signs measurement systems.

(2) Description of the Related Art

Current products fall mainly into two categories: personal emergency response systems (PERS), and telehealth. The PERS systems allow users to send an alarm signal to remote caregivers in order to request assistance in an emergency. These normally consist of a mobile device wirelessly connecting to a console, which communicates to caregivers via voice calls over standard analog telephone lines. The telehealth systems are for measurements and monitoring of users' health information, such as their vital signs. These are normally connected to remote caregivers using data, over the Internet or just using modems over analog telephone lines.

The disadvantages of these systems arise from the fact that they are separate systems which do not share data with each other. This creates operational difficulties and increases equipment costs. For example, vital sign measurements are taken by individual devices and the uploading of data often requires significant user interactions, which is very inconvenient to the users. Another major disadvantage is that their functionalities are strictly limited to the individual applications of PERS and telehealth, although data from telehealth systems are very useful to the PERS and vice versa. For example, in the event of an emergency handled by the PERS, the telehealth data in the form of personal health records (PHR) will be needed by the emergency crew (e.g. blood type). By combining telehealth into PERS, the PHR can be displayed by the PERS equipment, or alternatively, the PERS system may automatically send together with the alert signal a pre-programmed message to the caregivers to enable access to the PHR on the network.

There has been some work in combining these functions. U.S. Pat. No. 6,847,892 (Zhou et al—Digital Angel Corporation) discloses a system including wireless positioning, wireless communication, and sensing. Watch and/or belt units act as sensors and include a panic button (PERS function). Sensor output is monitored and alert messages are generated as necessary, including phone calls (telehealth).

U.S. Patent Application 2004/0030531 (Miller et al—Honeywell) describes a system including controllers, sensors, and effectors. Sensors can include personal medical information such as blood pressure, or motion sensors, environmental temperature sensors, etc. Effectors act on information received from sensors. For example, contact information is stored along with situations in which contact is to be made. If a panic button is pressed, a phone call is made.

U.S. Pat. No. 7,285,090 (Stivoric et al) discloses a shirt or armband worn by the user which collects personal data such as blood pressure, skin temperature, and so on. The data may be uploaded to a central monitoring unit. The user can also input data. The sensor can receive or transmit data. It can activate lights, program a treadmill, interact with a pacemaker, etc. The sensor device can send or receive alerts.

U.S. Pat. No. 7,154,398 (Chen et al) describes a real-time health monitoring system that can send alerts to the wearer or to the monitoring system. When a panic button is pressed, a call is placed and vital signs and location are transmitted.

U.S. Patent Application 2008/0064375 (Gottlieb—LogicMark) discloses an emergency calling system triggered by a panic button on a pendant. The emergency calling system can call a list of numbers or an emergency services number, based on pre-programmed criteria. This patent does not include telehealth functions.

### SUMMARY OF THE INVENTION

A principal object of the present invention is to provide a cost-effective and easy to use health management system for the home.

Another object of the invention is to provide health management system for the home that combines a personal emergency response system with vital signs measurement systems.

Yet another object of the invention is to provide a health management system in which a personal emergency response system device also functions as a gateway to collect and share personal health data with third-party servers.

A further object of the invention is to provide a health management system combining health data as part of alert events, and providing different levels of alert depending on the severity of the events.

In accordance with the objects of this invention, a health management system is achieved. The health management system comprises at least one console, one or more devices in two-way wireless communication with the console wherein the console acts as an intelligent gateway through which the one or more devices may communicate to external data and voice networks, and, an alert system wherein an alert is triggered by one or more of a user's action and pre-set alarm criteria and wherein the triggering of an alert causes the console to take an action.

Also in accordance with the objects of this invention, a health management system is achieved. The health management system comprises at least one console, one or more devices in two-way wireless communication with the console wherein the console acts as an intelligent gateway through which the one or more devices may communicate to external data and voice networks, an application gateway in communication with the at least one console wherein the application gateway interfaces with one or more third-party servers, and an alert system wherein an alert is triggered by one or more of a user's action and pre-set alarm criteria and wherein the triggering of an alert causes the console to take an action.

Also in accordance with the objects of the invention, a method for health management of a user is achieved. One or more devices are provided in two-way wireless communication with a console. Data is collected from the one or more devices and stored at the console. The data is uploaded to an application gateway in communication with the console wherein the application gateway sends the data to one or more third-party servers. An alert system is provided wherein an alert is triggered by one or more of a user's action and pre-set alarm criteria and wherein triggering of an alert causes the console to take an action.

### BRIEF DESCRIPTION OF THE DRAWINGS

In the accompanying drawings forming a material part of this description, there is shown:

FIG. 1 schematically illustrates an overview of the health management system of the present invention.

FIG. 2 schematically illustrates the dynamically programmable alert system of the present invention.

FIG. 3 illustrates an example of configurable user interface and device support logic of the present invention.

FIG. 4 illustrates a preferred embodiment of the console of the present invention.

### DESCRIPTION OF THE PREFERRED EMBODIMENTS

The present invention provides a health management system for the home that combines a personal emergency response system with vital signs measurement systems which are connected to external resources via the Internet or the public switched telephone networks, so as to provide total integration of home health management system with public health data services. Novel applications are supported by the combination of health information generated by the home health management system and also from the public health data services, leading to enhancement of features and more sophisticated responses.

Referring to FIG. 1, the health management system uses one or more consoles 10 to support one or more devices 12 wirelessly. The Console units may connect to external Application Gateway (AG) units 14 and other communication devices over analog phone lines, internet and wireless data and voice services. The system combines the collection of health data such as vital-sign measurements (sometimes known as telehealth measurements) from the user with communication through the console to external Application Gateways (AG). Third party consolidated service providers 16 can be connected to the system through the Application Gateway which acts as an intelligent conduit between the console and the third-party servers. The AG performs necessary protocol conversion between the console and the third party servers and also consolidates real-time data from the console (e.g. motion data) to summarize results meaningful for storage as personal health records (PHR). The AG can also update any related information from PHR to the consoles (e.g. caregivers' contact info) as needed. Examples of third party servers are: Google™ Health and Microsoft® Healthvault. These servers provide the means to store, organize, and share health information.

The System incorporates both telehealth and personal emergency response systems (PERS) functions. The Health monitoring system of the invention uses two-way wireless communication. Devices that can be connected to the system include stand-alone devices such as a weight scale, peak flow meter, glucose meter, blood pressure monitor, portable ECG/EKG device, CPAP machine, and many other devices. The configurations of the devices can be performed at the console with the convenience of a larger display and keypad. Alternatively, the devices can be configured remotely and the configuration information downloaded to the console from the remote system. The data is downloaded to the device in a manner transparent to the user. New features such as voice and network event notifications (e.g. event alert) can also be provided to the devices.

The health management system of the present invention is initially configured at the console. Alternatively, the system may be configured remotely wherein configuration information is input to the console by web-based, voice, or other forms of user input. The health management system may be reconfigured at any time either at the console or remotely.

Consoles may be stand-alone or networked and devices may operate with a single console. For networked consoles, devices may roam between consoles once they are paired with any one of the networked consoles. Multiple types of devices may operate with each other once they are paired with the same single console, or any one console within the same group of networked consoles.

One of the devices 12 may be a personal emergency response system (PERS) device, for example, on a watch or a pendant, or the like. For telehealth applications, the PERS device is a natural gateway for vital signs measurements to be routed through, or even taken directly at, the device. The routing of the data through the PERS device avoids user configuration by having pre-programmed configurations within the console, while the PERS device provides the unique user ID that selects the configuration data set.

For the PERS applications, many current products use one-way wireless technology. They are very simple, user-triggered alert systems where the device sends an alert signal to the base, but will not be able to receive anything back. The user does not know if the alarm is successfully triggered, and also does not have any ability to talk to the remote caregivers. The device does not know if it is out-of-range. In fact, there is no ability for the console to notify the device at all. The present invention uses two-way wireless technology so that there is feedback. The operation of the invention will now be described in detail.

The PERS can be activated by a user's action, but it can also be activated triggered by alarm criteria set by caregivers. Caregivers are provided with sufficient information to proactively manage the wellness of the subjects, such as setting alarm criteria which can be triggered based on data collected from the system. For example, motion information or the lack of it over a certain time period can be used as criteria. This is a generalization of the PERS application to use telehealth measurements data as part of the metrics for generating alerts. The PERS criteria can be used to generate different priorities of alerts which are triggered dependent on the data metrics received. For example, a top priority alert may be to call 911; a lower priority alert to make a call to the PERS call list, followed by Short Message Service (SMS), email, etc.

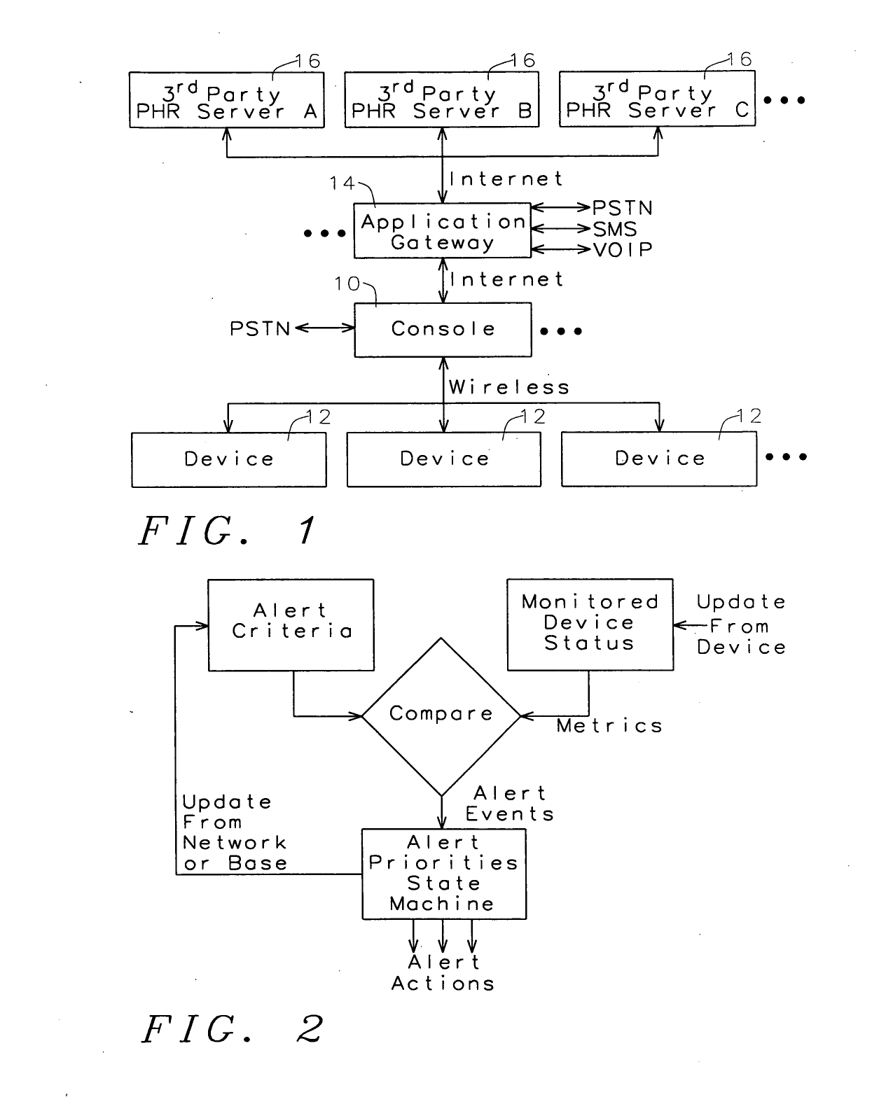

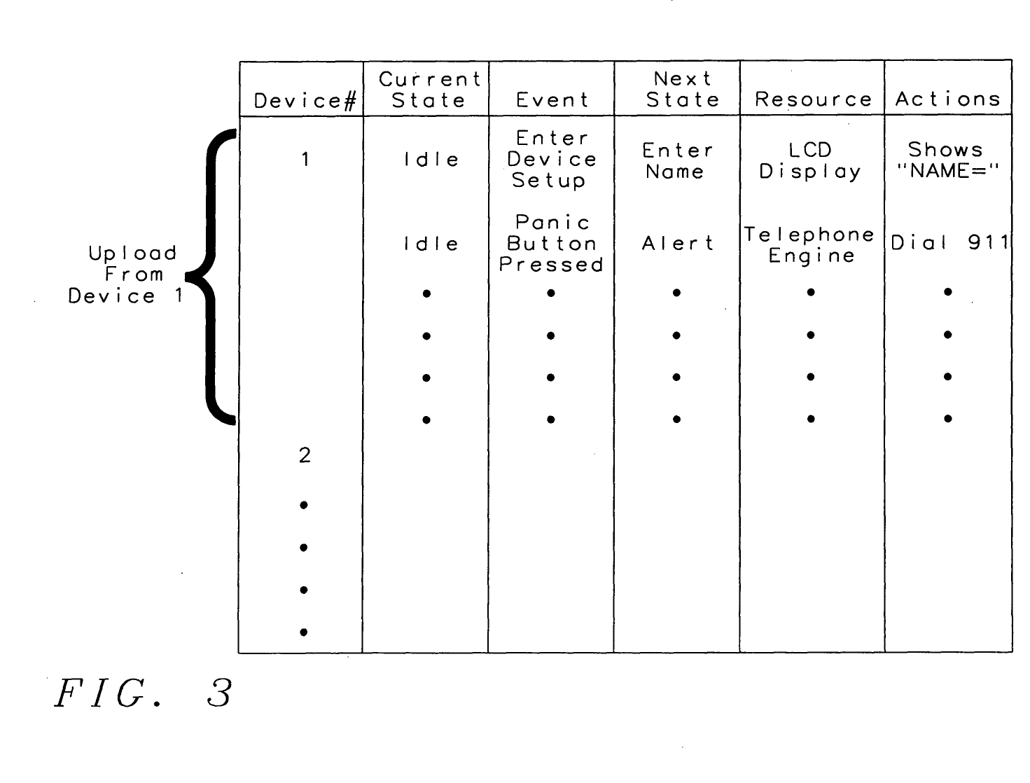

Pre-defined criteria for PERS alert events may be held as part of PHR on third-party servers, and is downloaded to the AG or consoles. User-generated data sent from the devices are evaluated at either the AG or consoles against alert criteria, and actions are taken according to the priorities of the alert events. The logic mapping of alert events to resulting actions may be implemented as a state machine and the priorities are determined according to past and current events. FIG. 2 provides a flowchart of a dynamically programmable alert system of the present invention.

The console implements a telephone call list as one of the PERS actions available. The call list will be called in sequence upon any alert criteria being met, such as a PERS alert event from a device, or some telehealth data metrics meeting alert criteria. The console calls each number in the telephone list with an outgoing message announcing the nature of the emergency with the message personalized using a pre-recorded message by the user of the device that triggers the emergency call. In the case of multiple devices, there may be one list per device, or alternatively, all devices may share the same list. The pre-recorded message may be fully customized to each device, or just with an ID or name for that device inserted within a general message.

Upon each call being made, the console will wait for a DTMF (TouchTone) signal being sent from the far end, and upon which it will remain off-hook and stop from calling all other numbers on the list. Otherwise, after a certain time period, it will hang up and proceed with calling the next number on the list. It will continue to call until a user action is taken to terminate the PERS event.

Upon detecting DTMF signal and maintaining the call by keeping the line off-hook, the console will monitor voice activities from the far end, and upon detection of continuous inactivity for a certain time-out period, will terminate the call. The detection of voice activities will be over a running window equivalent to the most recent accumulation of all time intervals in which the near end voice is below a pre-determined threshold. The effective duration of the running window will be equal to the time-out period.

The console may use received signal strength indication (RSSI) to determine the proximity of the devices being in contact with the console. The proximity will be used as a metric together with other information such as the device ID, to determine if action is to be taken. For example, a special-purpose console may be set up to generate an alarm upon a specific device ID being detected within its proximity, thus it can function as a gate keeper to guard against physical access by prohibited devices.

The console acts as an intelligent gateway through which one or more devices may communicate to external data and voice networks including: analog telephony, Voice over Internet Protocol (VOIP) over Ethernet or WiFi, and cellular wireless networks. It is intelligent in that information related to the unique ID's for the registered devices are stored and are used as decision metrics when actions are taken in response to external events. For example, when an emergency alert is received from a device, the user information may contain a list of caregivers and their contact emails and telephone numbers. The console may also have received updated contact information consoled on their caregivers' location; for example, when mobile caregivers are reporting their GPS locations. The console will then prioritize the call list based on proximity of the caregivers.

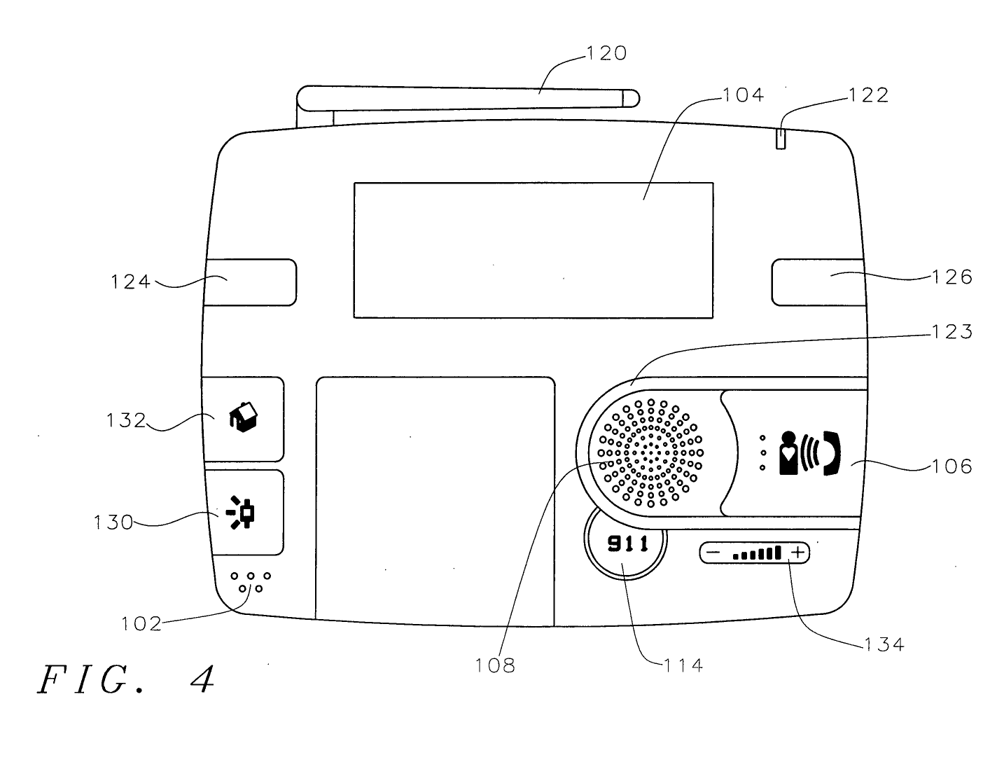

The console user interface (UI) logic and menu system is configurable by a data structure uploaded over-the-air from any new device that is registered to the console. The data structure defines the UI state machine logic, and how events from the UI and/or the device are to be handled by the available resources at the console. One realization of this concept is a state-transition table in which the entries are programmable data. FIG.3 provides an example of a state transition table.

The console provides both a PERS and an Emergency call button, where the PERS button triggers calling the PERS call-list, and the Emergency button triggers calling only the public emergency number (e.g. 911 for USA). An event triggered at the console will cause a speaker phone call at the console to be made, with Outgoing Message (OGM), for example, using only all customized names within the generic message.

FIG. 4 illustrates a preferred embodiment of the console of the invention. It will be understood that the console of the invention may differ in size and appearance and arrangement of components without departing from the spirit and scope of the invention. For example, console 10 includes a microphone 102 and speaker 108 for two-way communication. The Emergency call button 114 calls public emergency services, such as 911. The favorite help button 106 triggers calls to the PERS call list through the central station. The Home Away Button 132 allows one-touch notification of away from home status. The pre-programmed numbers are called to notify them that the user is away from home. The light emitting diode (LED) indicator light 122 will blink to indicate away status. A second touch of the Home Away Button 132 cancels blinking of the LED indicator and notifies the pre-programmed numbers of the return of the user to home. A page button 130 can be touched to locate the PERS device that may be worn as a watch, pendant, bracelet, or belt attachment, or the like. The console also includes a liquid crystal display 104, and programming buttons 124 and 126 for programming the console. A LED light ring 123 indicates the presence of the console in the dark. A volume up/down button 134 is also provided to control volume of the speaker 108. An antenna 120 facilitates wireless communication of the console with the various devices 12.

The Application Gateway provides protocol and data format adaptation between the console units and data servers which may be provided by third parties. Console units register with the AG using known domain name system (DNS) names or Internet protocol (IP) addresses, or via analog telephone lines and voice-band modems. The console periodically sends the AG a “keep-alive” message that must be acknowledged, and upon failure of acknowledgement, would initiate retries, and upon time-out would trigger registration with backup AG's.

The AG performs intelligent sorting and filtering of static data between the console and data servers according to a mapping table, such that only data types mapped between the console and the data servers are synchronized. The console keeps record of all data that are synchronized, and updates the AG whenever there is a change in such data. The AG uses the keep-alive acknowledgement messages to be informed of any changes of data from the Data Servers.

The AG may utilize information from third-party servers and effectuate relevant functions at the console and device. As an embodiment of this function, a medication record stored in a PHR server may be updated by a prescription service provider with a new medicine prescription, in which case the AG would detect a change in the record, retrieve the prescription information, converting it into a medication schedule, and download it into the console. The console will set up medication reminders and the wearable device will be updated with the alarm schedules. The user will then be notified at the scheduled medication events by the device. Notification can be audio and/or visual. As another embodiment of this function, an appointment schedule may be updated by a service provider, in which case the AG would retrieve the appointment schedule and download it into the console. The console will set up appointment reminders and the wearable device will be updated with the alarm schedules. The user will then be notified of the scheduled appointment times by the device. Notification can be audio and/or visual.

Emergency alert signals from the console may be sent to the AG as a data message over IP or voice-band data, in which case the AG may initiate other means of PERS alerts including emails, SMS, fax, and voice calls with prerecorded voice messages. The AG may also process acknowledgements including SMS, email, or instant messaging (IM) in response to its PERS alerts, upon which the AG will send a signal to the console to acknowledge receipt of the PERS alert and terminate the event.

The present invention provides many advantages. One advantage is the combined telehealth and PERS console. This provides ease of use by using the PERS Device as a personal gateway for routing of telehealth measurements, in the process adding the user ID with the data. There are cost savings in hardware by sharing wireless and network connections. Another advantage is the generalized PERS which combines health data as part of alert events, and provides different levels of alert depending on the severity of the events. Both current and historical events are evaluated using a state machine implementation and the alert criteria are captured deterministically within the state machine logic, which can be modified by simple uploading of a different state transition table. A third advantage is the integration of PHR information with the PERS alert. Consoles synchronize with third party servers hosting PHR via an AG. PHR information is updated from the consoles, as well as used by the consoles for PERS actions. A further advantage is networked consoles. The system becomes scalable by adding more console units to provide for larger coverage area and more devices. Pairing protocol allows a user to pair a device with any consoles within the network. The device becomes operational throughout the network. Yet another advantage is automatic call termination by the console upon far end inactivity. Existing products require either the far or the near end to press a key to prevent time-out call termination. A simple algorithm detects far-end inactivity in the presence of near-end line echo.

The present invention allows ease of user configuration and entry in local languages by the use of a PC (personal computer)-based program accepting user data entry, with the existing data first retrieved from the console over a data connection such as USB, and displayed by the PC program. User data may be entered in any languages and using any input methods supported by the PC, and the PC program will then convert the data into a graphics format acceptable by the console, and transfer the data back to the console over the data connection.

The present invention allows ease of remote configuration by the use of a data connection from a remote computer. The embodiments of the data connection include: telephone voice-band modems, Ethernet, Internet, and wireless connections. If the console is connected to the Internet, the remote computer may connect to the console using a dynamic DNS service to look up the IP address of the console, by referring to a known URL that corresponds to the console. If the console is connected to the analog telephone line, the remote computer may dial into the telephone number of the console and use a voice-band modem to transfer the configuration data. In all cases the remote computer may present the configuration setup process as a web-based form to the remote user performing the setup, and the form will contain the location information such as the URL or the telephone number that refers to the console being set up.

While the invention has been particularly shown and described with reference to the preferred embodiments thereof, it will be understood by those skilled in the art that various changes in form and details may be made without departing from the spirit and scope of the invention.

What is claimed is:

1. A health management system comprising:
at least one console;
one or more devices in two-way wireless communication with said console wherein said console acts as an intelligent gateway through which said one or more devices may communicate to external data and voice networks; and
an alert system wherein an alert is triggered by one or more of a user's action and pre-set alarm criteria and wherein said triggering of an alert causes said console to take an action.

2. The health management system according to claim 1 further comprising a plurality of consoles acting as stand-alone consoles or networked together.

3. The health management system according to claim 2 wherein said one or more devices communicate with any of said plurality of consoles that are networked together.

4. The health management system according to claim 1 wherein said one or more devices communicate to external data and voice networks by one or more of the following: analog telephony, Voice over Internet Protocol (VOIP) over Ethernet, WiFi, and cellular wireless networks.

5. The health management system according to claim 1 wherein a new device can be added to said health management system at any time and wherein adding said new device comprises configuring said new device at said console or configuring said new device at a remote system wherein configuration information is downloaded from said remote system to said console.

6. The health management system according to claim 1 wherein said user's action comprises pushing a button on said console or on one of said devices.

7. The health management system according to claim 1 wherein said alarm criteria comprises analysis of output from one or more of said devices.

8. The health management system according to claim 1 wherein said action comprises placing a telephone call to a public emergency number and playing a pre-recorded message including personal health data.

9. The health management system according to claim 8 wherein said personal health data comprises:
data collected from said one or more devices; and
data stored on third party servers wherein said data on said third-party servers is updated from said console using said data collected and is used by said console.

10. The health management system according to claim 1 wherein said action comprises sending emails, SMS, fax, and voice calls with prerecorded voice messages to a list of contacts associated with said alert.

11. The health management system according to claim 1, further comprising:
an application gateway in communication with said at least one console wherein said application gateway performs said action upon receiving said alert from said console.

12. The health management system according to claim 11 wherein said alert system is dynamically programmable at said console or through said application gateway from a third-party server.

13. The health management system according to claim 12 wherein:
medication prescription information is able to be provided by said third party server wherein said medication prescription information comprises a medication schedule;
said medication prescription information is able to be sent by said third party server to said console through said application gateway;
said console sends alert messages to a wearable one of said one or more devices according to said medication schedule; and
said wearable device generates audio or visual alerts autonomously using information from said medication schedule.

14. The health management system according to claim 12 wherein:
appointment information is able to be provided by said third party server wherein said appointment information comprises an appointment schedule;
said appointment information is able to be sent by said third party server to said console through said application gateway;
said console sends alert messages to a wearable one of said one or more devices according to said appointment schedule; and
said wearable device generates audio or visual alerts autonomously using information from said appointment schedule.

15. The health management system according to claim 11 wherein said action comprises sending alerts by email, SMS, fax, or voice calls with pre-recorded voice messages, and wherein said application gateway processes acknowledgments of receipt of said alerts, and wherein said application gateway sends a signal to said console to acknowledge receipt of said alerts.

16. The health management system according to claim 15 wherein said action depends upon the level of said alert wherein said level is based on said alarm criteria.

17. The health management system according to claim 11 wherein said action comprises data connection from the application gateway to the console by means comprising voice-band modems, Ethernet and internet, so that said application gateway makes initial connection to said console by dialing the telephone number of said console, or discovering the IP address of said console from a dynamic DNS lookup service using the URL of said console.

18. The health management system according to claim 17 wherein said action comprises transmission of configuration data from said application gateway to said console wherein said configuration data comprises PERS telephone numbers, medication reminder schedules, emergency contact information, and outgoing messages.

19. The health management system according to claim 18 wherein said action comprises said application gateway's obtaining said configuration data and console telephone number and/or URL from human input into a form presented electronically by said application gateway over the internet.

20. The health management system according to claim 1 wherein said health management system is configured at said console or by downloading information to said console by dial-in from a server, input into an internet-based configuration program, voice, or other forms of user input.

21. A health management system comprising:
at least one console;
one or more devices in two-way wireless communication with said console wherein said console acts as an intelligent gateway through which said one or more devices may communicate to external data and voice networks;
an application gateway in communication with said at least one console wherein said application gateway interfaces with one or more third-party servers; and
an alert system wherein an alert is triggered by one or more of a user's action and pre-set alarm criteria and wherein said triggering of an alert causes said console to take an action.

22. The health management system according to claim 21 further comprising a plurality of consoles acting as stand-alone consoles or networked together.

23. The health management system according to claim 22 wherein said one or more devices communicate with any of said plurality of consoles that are networked together.

24. The health management system according to claim 21 wherein said one or more devices communicate to external data and voice networks by one or more of the following: analog telephony, Voice over Internet Protocol (VOIP) over Ethernet, WiFi, and cellular wireless networks.

25. The health management system according to claim 21 wherein a new device can be added to said health management system at any time and where adding said new device comprising configuring said new device at said console or configuring said new device at a remote system wherein configuration information is downloaded from said remote system to said console.

26. The health management system according to claim 21 wherein said user's action comprises pushing a button on said console or on one of said devices.

27. The health management system according to claim 21 wherein said alarm criteria is dynamically adjusted based on input data from said one or more devices, input data from said third-party servers, and programmed alarm criteria updates provided by a user.

28. The health management system according to claim 21 wherein said action comprises placing a telephone call to a public emergency number and playing a pre-recorded message including personal health data.

29. The health management system according to claim 28 wherein said personal health data comprises:
data collected from said one or more devices; and
data stored on said third party servers wherein said data on said third-party servers is updated from said console using said data collected and is used by said console.

30. The health management system according to claim 21 wherein said action comprises sending emails, SMS, fax, and voice calls with prerecorded voice messages to a list of contacts associated with said alert.

31. The health management system according to claim 21 wherein said alert system is dynamically programmable at said console or through said application gateway from said one or more third-party servers.

32. The health management system according to claim 21 wherein:
medication prescription information is able to be provided by at least one of said third party servers wherein said medication prescription information comprises a medication schedule;
said medication prescription information is able to be sent by said third party server to said console through said application gateway;
said console sends alert messages to a wearable one of said one or more devices according to said medication schedule; and
said wearable device generates audio or visual alerts autonomously using information from said medication schedule.

33. The health management system according to claim 21 wherein said action comprises sending alerts by email, SMS, fax, or voice calls with pre-recorded voice messages, and wherein said application gateway processes acknowledgments of receipt of said alerts, and wherein said application gateway sends a signal to said console to acknowledge receipt of said alerts.

34. The health management system according to claim 33 wherein said action depends upon the level of said alert wherein said level is based on said alarm criteria.

35. The health management system according to claim 21 wherein said action comprises data connection from the application gateway to the console by means comprising voice-band modems, Ethernet and internet, so that said application gateway makes initial connection to said console by dialing the telephone number of said console, or discovering the IP address of said console from a dynamic DNS lookup service using the URL of said console.

36. The health management system according to claim 35 wherein said action comprises transmission of configuration data from said application gateway to said console wherein said configuration data comprises PERS telephone numbers, medication reminder schedules, emergency contact information, and outgoing messages.

37. The health management system according to claim 36 wherein said action comprises said application gateway's obtaining said configuration data and console telephone number and/or URL from human input into a form presented electronically by said application gateway over the internet.

38. The health management system according to claim 21 wherein said health management system is configured at said console or remotely by downloading configuration information to said console by dial-in from a server, input into an internet-based configuration program, voice, or other forms of user input.

39. A method for health management of a user comprising:
providing one or more devices in two-way wireless communication with a console;
collecting data from said one or more devices and storing said data at said console;
uploading said data to an application gateway in communication with said console wherein said application gateway sends said data to one or more third-party servers; and
providing an alert system wherein an alert is triggered by one or more of a user's action and pre-set alarm criteria and wherein said triggering of an alert causes said console to take an action.

40. The method according to claim 39 further comprising providing a plurality of consoles acting as stand-alone consoles or networked together.

41. The method according to claim 40 wherein said one or more devices communicate with any of said plurality of consoles that are networked together.

42. The method according to claim 39 wherein said one or more devices communicate to external data and voice networks by one or more of the following: analog telephony, Voice over Internet Protocol (VOIP) over Ethernet, WiFi, and cellular wireless networks.

43. The method according to claim 39 further comprising adding a new device comprising configuring said new device at said console or configuring said new device at a remote system wherein configuration information is downloaded from said remote system to said console.

44. The method according to claim 39 wherein said user's action comprises pushing a button on said console or on one of said devices.

45. The method according to claim 39 wherein said alarm criteria is dynamically adjusted based on input data from said one or more devices, input data from said third-party servers, and programmed alarm criteria updates provided by a user.

46. The method according to claim 39 wherein said action comprises placing a telephone call to a public emergency number and playing a pre-recorded message including personal health data.

47. The method according to claim 46 wherein said personal health data comprises:
data collected from said one or more devices; and
data stored on said third party servers wherein said data on said third-party servers is updated from said console using said data collected and is used by said console.

48. The method according to claim 39 wherein said action comprises sending emails, SMS, fax, and voice calls with prerecorded voice messages to a list of contacts associated with said alert.

49. The method according to claim 39 wherein said alert system is dynamically programmable at said console or through said application gateway from said one or more third-party servers.

50. The method according to claim 39 further comprising:
downloading medication prescription information including a medication schedule from one of said third party servers to said console through said application gateway; and
sending alert messages from said console to a wearable one of said one or more devices according to said medication schedule.

51. The method according to claim 39 wherein said action comprises sending alerts by email, SMS, fax, or voice calls with pre-recorded voice messages, and wherein said application gateway processes acknowledgments of receipt of said alerts, and wherein said application gateway sends a signal to said console to acknowledge receipt of said alerts.

52. The method according to claim 51 wherein said action depends upon the level of said alert wherein said level is based on said alarm criteria.

53. The method according to claim 39 wherein said action comprises data connection from the application gateway to the console by means comprising voice-band modems, Ethernet and internet, so that said application gateway makes initial connection to said console by dialing the telephone number of said console, or discovering the IP address of said console by a dynamic DNS lookup service of the URL of said console.

54. The method according to claim 53 wherein said action comprises transmission of configuration data from said application gateway to said console wherein said configuration data comprises PERS telephone numbers, medication reminder schedules, emergency contact information, and outgoing messages.

55. The method according to claim 54 wherein said action comprises said application gateway's obtaining said configuration data and console telephone number and/or URL from human input into a form presented electronically by said application gateway over the internet.

56. The method according to claim 39 further comprising inputting information into said console or downloading information to said console by dial-in from a server, input into an internet-based configuration program, voice, or other forms of user input.
